(19) United States
(12) Patent Application Publication
(10) Pub. No.: US 2012/0174634 A1
(43) Pub. Date: Jul. 12, 2012

(54) CLOSURE SYSTEM

(75) Inventor: Joerg GSCHWENG, Mainz (DE)

(73) Assignee: GM GLOBAL TECHNOLOGY OPERATIONS LLC, Detroit, MI (US)

(21) Appl. No.: 13/312,434

(22) Filed: Dec. 6, 2011

(30) Foreign Application Priority Data
Dec. 7, 2010 (DE) 102010053620.2

(51) Int. Cl. E05B 17/18; B60R 99/00

(52) U.S. Cl. 70/237; 70/455

(57) ABSTRACT

A closure system is provided, in particular for a motor vehicle, having a lock device, which is arranged in or on the outer side of a wall element, in particular of a motor vehicle, and which has an opening, into which an unlocking and/or locking device, which is implemented as corresponding to the opening in particular and is manual in particular, is insertable in an insertion direction, and having a cover device, which can be or is arranged on the lock device, so that it entirely covers the opening of the lock device at least in the insertion direction, and which is at least partially removable from the lock device to expose the opening for the unlocking and/or locking device.

### CROSS-REFERENCE TO RELATED APPLICATION

This application claims priority to German Patent Application No. 10 2010 053 620.2, filed Dec. 7, 2010, which is incorporated herein by reference in its entirety.

### TECHNICAL FIELD

The technical field relates to a closure system, a cover device for such a closure system, and a method for covering and reclosing an opening of a lock device.

### BACKGROUND

Closure systems, in particular for motor vehicles, are known. Closure systems are used, for example, for the purpose of closing and/or opening a wall element implemented as a vehicle door. Since a motor vehicle is typically subjected to weather conditions, the opening of a lock cylinder is to be protected from the penetration of dirt and moisture, in order to maintain its functionality. The known closure systems preferably have a displaceable element, which is displaced by the insertion of an unlocking and/or locking means, such as a key, in such a manner that the key is insertable into the opening. When the displaceable element is not displaced, it protects the opening from the penetration of dirt and moisture.

A closure system is known from EP 0 709 532 A1, in which a displaceable element implemented as a flap is displaceable by a key by rotating around a rotational axis in such a manner that the key is insertable into the opening of the lock cylinder. It has proven to be disadvantageous in this case that the flap requires sufficient space during the rotation around the axis to be able to be rotated so that the key is insertable into the opening of the lock cylinder. The depth and width of the required space therefore at least comprise the length of the flap. A cavity is therefore to be provided in front of the opening of the lock cylinder, which must be taken into consideration in the design of the closure system.

In modern closure systems, the closure system is solely unlocked or locked by the unlocking and/or locking means, which is in particular manual, if an electronic unlocking and/or locking means is not usable. This can be the case if the electrical energy storage of an electrical key is discharged in such a manner that unlocking or locking of the lock device is no longer possible, for example.

At least one object is to propose a closure system that is protected against the penetration of dirt and moisture and has a compact construction. In addition, other objects, desirable features, and characteristics will become apparent from the subsequent summary and detailed description, and the appended claims, taken in conjunction with the accompanying drawings and this background.

### SUMMARY

A closure system is provided, in particular for a motor vehicle, having a lock device, which is arranged in or on the outer side of a wall element, in particular of a motor vehicle, and which has an opening, into which an unlocking and/or locking means, which is implemented corresponding to the opening in particular and is manual in particular, is insertable in an insertion direction, and having a cover device, which can be or is arranged on the lock device, so that it entirely covers the opening of the lock device at least transversely to the insertion direction and is at least partially removable from the lock device, in order to expose the opening for the unlocking and/or locking means.

The cover device can comprise an arbitrary shape. For example, it can be implemented like a plug and can be arranged directly or indirectly in or on the opening of the lock device. In such a case, a cavity which must be provided in the known closure systems may be omitted. The closure system can have a compact construction in this way. The compact construction of the closure system allows other applications to be provided in the wall element or the wall element to be made thinner. Transversely is understood as angles of essentially 90°.

In an embodiment, the cover device can be or is arranged pressing against a front face, which is arranged perpendicularly to the insertion direction, of the lock device, or the cover device has a distance to the front face of the lock device of less than approximately 10 mm, in particular less than approximately 5 mm, in particular less than approximately 3 mm. The closure system can be implemented very compactly in such a case. The cover device can be situated pressing directly against the lock device or can be arranged indirectly on the front face of the lock device.

The lock device can be arranged entirely or partially in the wall element. If the lock device is arranged entirely in the wall element, it has proven to be advantageous if the front face is arranged flush with an external surface of the wall element. It has proven to be advantageous if the cover device is entirely and/or partially detachable from the lock device or is displaceably removable entirely or partially, in particular diagonally or transversely to the insertion direction. For example, the cover device can be permanently or removably fastened on the lock device and can have a removable closure element at the height of the opening. In addition, it is conceivable that the cover device comprises a closure element implemented as a slide, which is displaceable transversely to the insertion direction. The cover device can fundamentally be implemented arbitrarily. For example, it can comprise a shape so that it only covers the opening of the lock device.

In an embodiment, it is provided that the cover device has a cap-like section. The cap-like section can laterally overlap the lock device. It can form an undercut with respect to the insertion direction with the lock device in this case. In such a case, the cap-like section can be clipped onto the lock device, for example. It is fundamentally conceivable that the cover device is only formed by the cap-like section. It preferably extends essentially transversely to the insertion direction. However, it is preferable if the cover device has at least one nub-like body, which extends from the cap-like section in the direction of the lock device, in particular at least partially protrudes into the opening of the lock device, if the cover device is arranged on the lock device.

The nub-like body can be removably or permanently connected to the cap-like section or can comprise a separate component. In the latter case, it is preferably supported on one side in relation to the cap-like section. Because the nub-like body at least partially protrudes into the opening of the lock device, it is held therein and fixes the cover device on the lock device. It is preferable if the nub-like body is fixedly connected to the cap-like section. In such a case, the cover device can be fixed easily on the lock device. The nub-like body then forms a retaining device.

In an embodiment, it has proven to be advantageous if the nub-like body forms a first sealing means. In such a case, the danger of penetration of moisture and dirt into the opening is further reduced. In addition, it has proven to be advantageous if the nub-like body is implemented as complementary to the opening of the lock device in at least one section. In such a case, the nub-like body can comprise a so-called dummy key, for example, which closes the opening if an unlocking and/or locking means is not to be inserted into the opening and which is readily to be removed again if the unlocking and/or locking means is to be inserted into the opening of the lock device. In addition, the sealing action can be increased in this way.

In an embodiment, it is provided that the cover device comprises a second sealing means, which is supported in relation to the lock device and/or is arranged entirely or partially around the protrusion around the nub-like body, in particular encloses the nub-like body in the form of a collar or circle. The second sealing means is preferably arranged on a surface of the cap-like section which faces toward the front face of the lock device. However, it is also conceivable that the second sealing means presses against a surface of the lock device which runs essentially parallel to the insertion direction.

The cover device can fundamentally be produced from an arbitrary material. However, it has proven to be advantageous if the cover device comprises multiple plastic components, in particular the cap-like section comprises a hard component and/or the first sealing means and/or the second sealing means comprises a soft component.

In an embodiment, it has proven to be advantageous if the cover device at least partially encloses the lock device and/or if the cover device forms a sealing means of a sealing device for the lock device. In such a case, the lock device can be implemented in or on the wall element of the motor vehicle in such a manner that it is entirely sealed to the outside. In a further embodiment of this embodiment, it has proven to be advantageous if the cover device comprises a sealing lip. If the cover device entirely encompasses the lock device, a material excess can form the sealing lip. It may preferably be fixed like a plug in the opening of the lock device.

The lock device can fundamentally be arranged in or on the outer side of a wall element. For example, the lock device can be arranged entirely in the wall element in such a manner that only the front face of the lock device is externally accessible. In an embodiment, however, it is provided that the lock device is arranged at least partially in a handle device, in particular of a motor vehicle, and/or the cover device forms a section of the handle device.

A cover device is also provided for a closure system having one or more of the above-mentioned features, and a method is provided for covering and reclosing an opening of a lock device, in which a cover device is arranged on the lock device to close the opening, and the cover device is entirely or partially removed if an unlocking and/or locking means is inserted into the opening of the lock device.

The closure system has proven to be advantageous in multiple aspects. Because the cover device can be arranged on the lock device and removed again, it is producible easily and cost-effectively.

In addition, the cover device can be arranged directly on the front face of the lock device. The entire system made of lock device and cover device can thus be implemented in a space-saving way, whereby the closure system is implementable compactly. Because the closure system can be implemented compactly, the wall element can be implemented as narrower or additional applications, which can be installed through the space savings, can be provided.

### BRIEF DESCRIPTION OF THE DRAWINGS

The present invention will hereinafter be described in conjunction with the following drawing figures, wherein like numerals denote like elements, and:

FIG. 1 shows a sectional view through a first embodiment of the closure system;

FIG. 2 shows a sectional view through a second embodiment of the closure system; and

FIG. 3 shows a sectional view through a third embodiment of the closure system in a handle.

### DETAILED DESCRIPTION

The following detailed description is merely exemplary in nature and is not intended to application and uses. Furthermore, there is no intention to be bound by any theory presented in the preceding background or summary or the following detailed description.

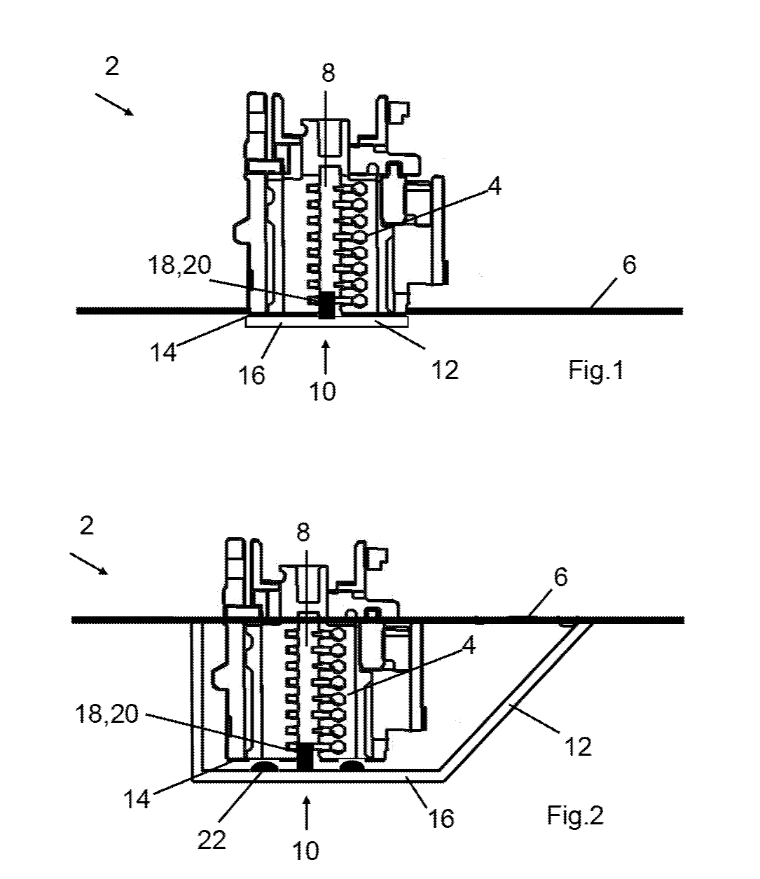

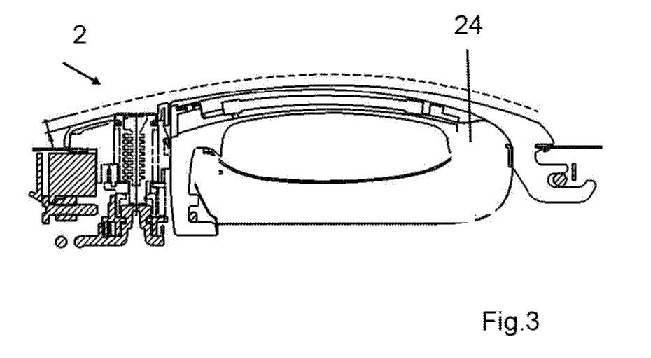

The figures show a closure system provided as a whole with the reference numeral 2, in particular for a motor vehicle. The closure system 2 has a lock device 4, which is arranged in FIG. 1 in the outer side of the wall element 6 and in FIGS. 2 and 3 on the outer side of the wall element 6. The lock device 4 has an opening 8, into which an unlocking and/or locking means (not shown in the figures), which is implemented corresponding to the opening 8 in particular and is manual in particular, is insertable in an insertion direction 10. In addition, the closure system 2 has a cover device 12, which can be arranged on the lock device 4 in such a manner that it entirely covers the opening 8 of the lock device 4.

FIG. 1 shows a first exemplary embodiment of the closure system 2. The closure system 2 presses against a front face 14 of the lock device 4 using a cap-like section 16. The cover device has a nub-like body 18 permanently connected to the cap-like section 16 of the cover device 12. The nub-like body 18 is inserted into the opening 8 of the lock device 4 in such a manner that the opening 8 is entirely filled up. The nub-like body 18 forms a first sealing means 20 in this way. In addition, the cover device 12 is fixed on the lock device 4 by the nub-like body 18 inserted into the opening 8.

In the first exemplary embodiment of the closure system shown in FIG. 1, the lock device 4 is entirely arranged in the wall element 6. In addition, the cover device 12 is implemented particularly compactly. In this way, the closure system 2 is implementable particularly compactly.

FIG. 2 shows a second exemplary embodiment of the closure system 2. In this case, the lock device is partially arranged in the wall element 6 and additionally protrudes outward somewhat. The cover device 12 is implemented like a cap in the exemplary embodiment shown in FIG. 2 and entirely encloses the lock device 4 in such a manner that the lock device 4 is entirely externally enclosed by the cover device 12. In the exemplary embodiment shown in FIG. 2, the nub-like body 18 is also provided and inserted into the opening 8 of the lock device 4. In order to further increase the sealing action of the cover device 12, a second sealing means 22 is provided, which extends in the form of a ring around the nub-like body 18. The second sealing means 22 is fixedly connected to the cap-like section 16 of the cover device 12 and is supported in the exemplary embodiment shown in FIG. 2 in relation to the front face 14 of the lock device 4.

FIG. 3 shows a third exemplary embodiment of the closure system 2, in which the lock device 4 and the cover device 12 are partially arranged on a handle device 24. The wall element is readily displaceable by the handle device 24 in this way when the lock device 4 is unlocked.

The features of the invention disclosed in the above description, the claims, and the drawings can be essential both individually and also in any arbitrary combination for the implementation of the invention in its various embodiments. Moreover, while at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A closure system for a motor vehicle, comprising:
a lock device arranged with respect to an outer side of a wall element
an opening corresponding to an unlocking device and manually insertable in an insertion direction and
a cover device arranged on the lock device and configured to entirely covers the opening at least transversely to the insertion direction and at least partially removable from the lock device to expose the opening for the locking device.

2. The closure system according to claim 1, wherein the cover device presses against a front face of the lock device arranged perpendicularly to the insertion direction.

3. The closure system according to claim 1, wherein the cover device is least partially detachable from the lock device.

4. The closure system according to one of the claim 1, wherein the cover device comprises a cap-like section.

5. The closure system according to claim 4, wherein the cover device comprises at least one nub-like body, which extends from the cap-like section in a direction of the lock device.

6. The closure system according to claim 5, wherein the nub-like body forms a first sealing.

7. The closure system according to claim 5, wherein the nub-like body is complementary to the opening of the lock device in at least one section.

8. The closure system according to claim 5, wherein the cover device comprises a second sealing that is supported in relation to the lock device.

9. The closure system according to claim 1, wherein the cover device comprises a plurality of plastic components.

10. The closure system according to claim 1, wherein the cover device at least partially encloses the lock device and the cover device forms a sealing of a sealing device for the lock device.

11. The closure system according to claim 1, wherein the cover device comprises a sealing lip.

12. The closure system according to claim 1, wherein the lock device is at least partially arranged in a handle device and the cover device forms a section of the handle device.

13. (canceled)

14. A method for covering and reclosing an opening of a lock device, comprising:
arranging a cover device on the lock device to close the opening; and
at least partially removing the cover device if an unlocking device is inserted into the opening of the lock device.

15. The closure system according to claim 2, wherein the cover device is a distance of less than approximately 10 mm to the front face of the lock device.

16. The closure system according to claim 2, wherein the cover device is a distance of less than approximately 5 mm to the front face of the lock device.

17. The closure system according to claim 2, wherein the cover device is a distance of less than approximately 3 mm to the front face of the lock device.

18. The closure system according to claim 1, wherein the cover device is partially displaceably transversely to the insertion direction.

19. The closure system according to claim 5, wherein the cover device protrudes at least partially into the opening of the lock device when the cover device is arranged on the lock device.

20. The closure system according to claim 5, wherein the cover device comprises a second sealing that is arranged at least partially around the nub-like body and encloses the nub-like body in a form of a circle.

21. The closure system according to claim 4, wherein the cap-like section comprises a hard component and the first sealing comprises a soft component.
